(19) United States
(12) Patent Application Publication
(10) Pub. No.: US 2005/0146890 A1
(43) Pub. Date: Jul. 7, 2005

(54) Vehicle light with a large illumination area

(76) Inventor: Shih-Hsiung Wu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/750,953

(22) Filed: Jan. 5, 2004

(51) Int. Cl. F21V 7/00

(52) U.S. Cl. 362/545; 362/347

(57) ABSTRACT

A vehicle light includes a base having an open side and a light-transmittable member attached to the open side of the base. The base includes an inner reflective surface that has a protrusion formed on a central portion thereof. The protrusion is covered with a reflective material. A circuit ring is mounted to the open side of the base. A plurality of spaced light-emitting diodes are mounted on the circuit ring. A light beam emitted by each light-emitting diode is incident on the protrusion to provide a convergent effect. The light beams are then reflected by the protrusion and the inner reflective surface to provide a large illumination area.

### BACKGROUND OF THE INVENTION

1. Field of the Invention

The present invention relates to a vehicle light with a large illumination area. In particular, the present invention relates to a vehicle light that provides a large illumination area after reflection.

2. Description of the Related Art

A vehicle light provides illumination, warning, and/or aesthetic effects. A conventional vehicle light includes a light bulb with a tungsten filament. Nevertheless, such a light bulb is apt to burn out and break, and the light beams emitted by the light bulb are dazzling.

Light-emitting diodes (LEDs) have been developed and used in the vehicle lights, as the light beams emitted by LEDs are soft and as it is difficult for the LEDs to break. The LEDs emit convergent light beams, which provides a poor halo effect that might be ignored by the drivers of the vehicles in the reverse direction. To solve this problem, vehicle lights using scattering effect of LEDs have been proposed to provide a large illumination area. The halo effect is, however, still unsatisfactory even if the LEDs are specifically arranged. Further, an aesthetic and eye-catching visual effect cannot be obtained.

### SUMMARY OF THE INVENTION

In accordance with an aspect of the present invention, a vehicle light includes a base having an open side and a light-transmittable member attached to the open side of the base. The base includes an inner reflective surface that has a protrusion formed on a central portion thereof. The protrusion is covered with a reflective material. A circuit ring is mounted to the open side of the base. A plurality of spaced light-emitting diodes are mounted on the circuit ring. A light beam emitted by each light-emitting diode is incident on the protrusion to provide a convergent effect. The light beams are then reflected by the protrusion and the inner reflective surface to provide a large illumination area.

The inner reflective surface includes a plurality of particles provided thereon. The particles are made of a reflective material. The protrusion has an arcuate surface.

Other objects, advantages, and novel features of the invention will become more apparent from the following detailed description when taken in conjunction with the accompanying drawings.

### BRIEF DESCRIPTION OF THE DRAWINGS

FIG. 1 is an exploded perspective view of a vehicle light in accordance with the present invention.

FIG. 2 is a sectional view of the vehicle light in accordance with the present invention.

FIG. 3 is a perspective view of the vehicle light in accordance with the present invention.

FIG. 4 is a sectional view similar to FIG. 2, illustrating light beams emitted by the LEDs of the vehicle light in accordance with the present invention.

FIG. 5 is a sectional view similar to FIG. 4, illustrating reflection of the light beams.

FIG. 6 is an exploded perspective view illustrating a modified embodiment of the vehicle light in accordance with the present invention.

FIG. 7 is a perspective view illustrating another modified embodiment of the vehicle light in accordance with the present invention.

FIG. 8 is a perspective view illustrating a further modified embodiment of the vehicle light in accordance with the present invention.

FIG. 9 is an exploded perspective view illustrating still another modified embodiment of the vehicle light in accordance with the present invention.

FIG. 10 is a rear perspective view of the vehicle light in FIG. 9.

FIG. 11 is a perspective view illustrating yet another modified embodiment of the vehicle light in accordance with the present invention.

FIG. 12 is a sectional view of the vehicle light in FIG. 11.

FIG. 13 is a perspective view illustrating still another modified embodiment of the vehicle light in accordance with the present invention.

FIG. 14 is a sectional view of the vehicle light in FIG. 13.

FIG. 15 is a perspective view illustrating yet another modified embodiment of the vehicle light in accordance with the present invention.

FIG. 16 is a sectional view of the vehicle light in FIG. 15.

### DETAILED DESCRIPTION OF THE PREFERRED EMBODIMENTS

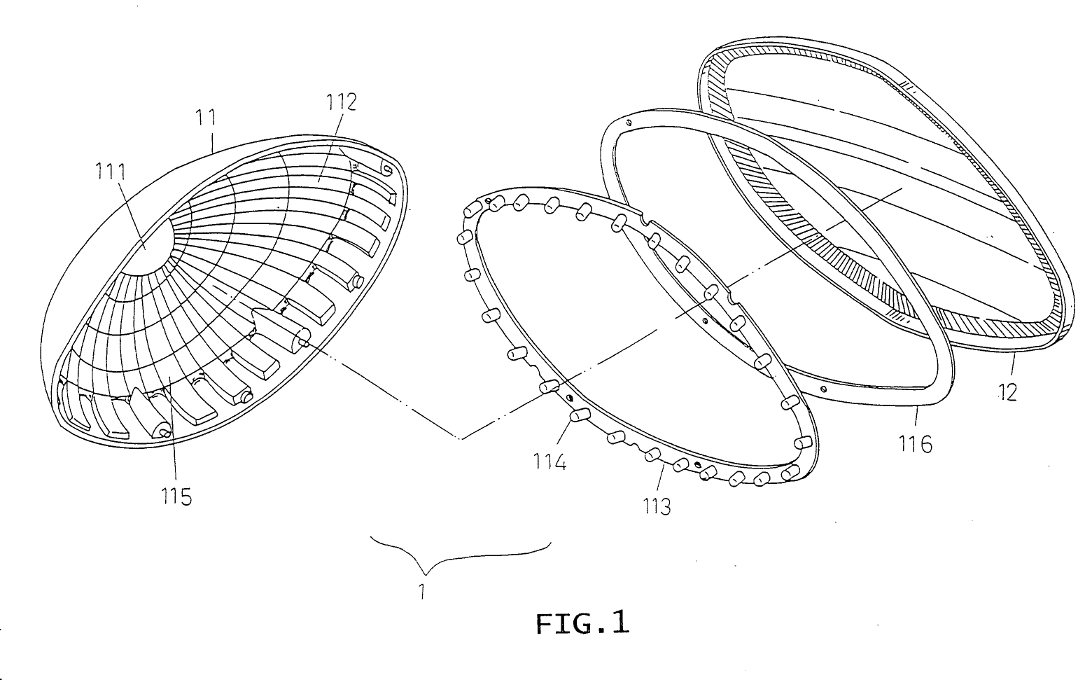

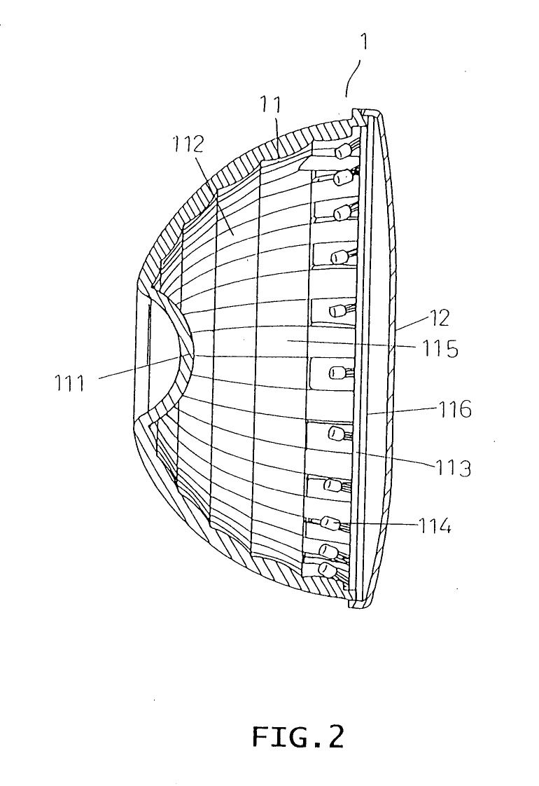

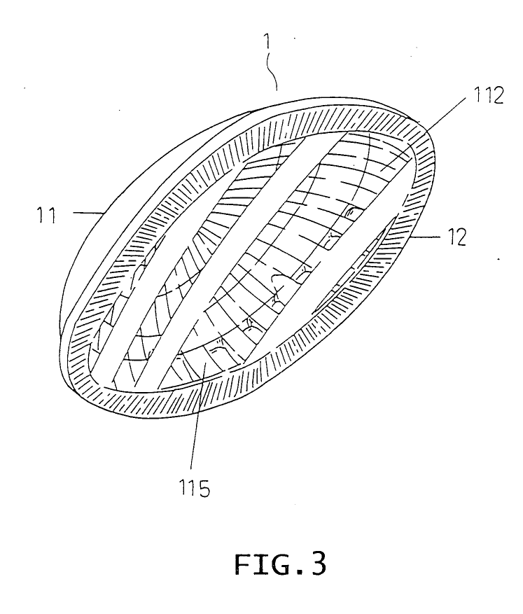

Referring to FIGS. 1 through 3, a vehicle light 1 in accordance with the present invention generally comprises a base 11 and a light-transmittable member 12 (such as transparent glass or the like) attached to a side of the base 11. The base 11 is in the form of a casing having an open side to which the light-transmittable member 12 is attached. The base 11 includes an inner reflective surface 112, with a protrusion 111 being formed on a central portion of the inner reflective surface 112. The protrusion 111 has an arcuate surface covered with a reflective material. Further, a plurality of particles 115 made of a reflective material are provided on the inner reflective surface 112, except for the protrusion 111.

Attached to the open side of the base 11 and located inside an inner perimeter (not labeled) of the light-transmittable member 12 is a circuit ring 113 on which a plurality of spaced light-emitting diodes (LEDs) 114 are mounted. The LEDs 114 may provide different colors when excited. More specifically, the LEDs 114 are coupled to a layout (not shown) and a switch means (not labeled) in the circuit ring 113 to emit light beams of at least one color. Optionally, a decorative ring 116 is mounted outside the circuit ring 113.

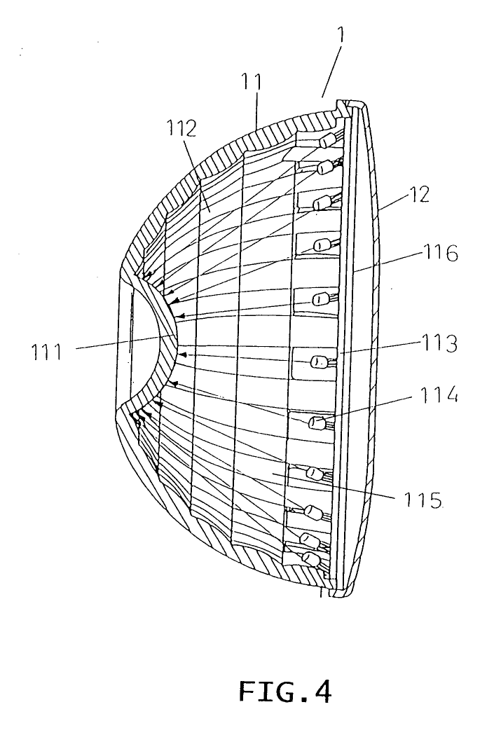

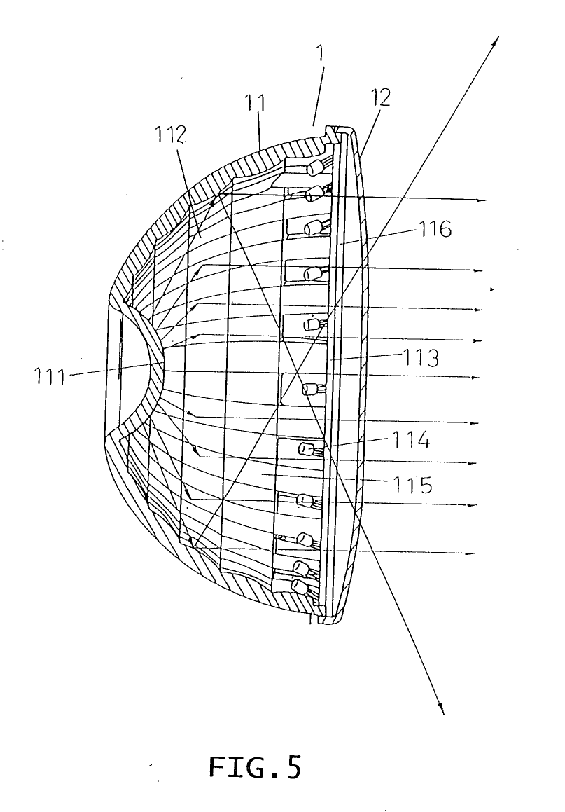

Referring to FIG. 4, the light beam emitted by each LED 114 is incident on the protrusion 111 covered with a reflective material, providing a convergent effect. As illustrated in FIG. 5, the light beams incident on the protrusion 111 are reflected twice (by the protrusion 111 and then by the inner reflective surface 112) into parallel light beams that transmit the light-transmittable member 12. A larger illumination area is thus provided, which provides an improved halo effect.

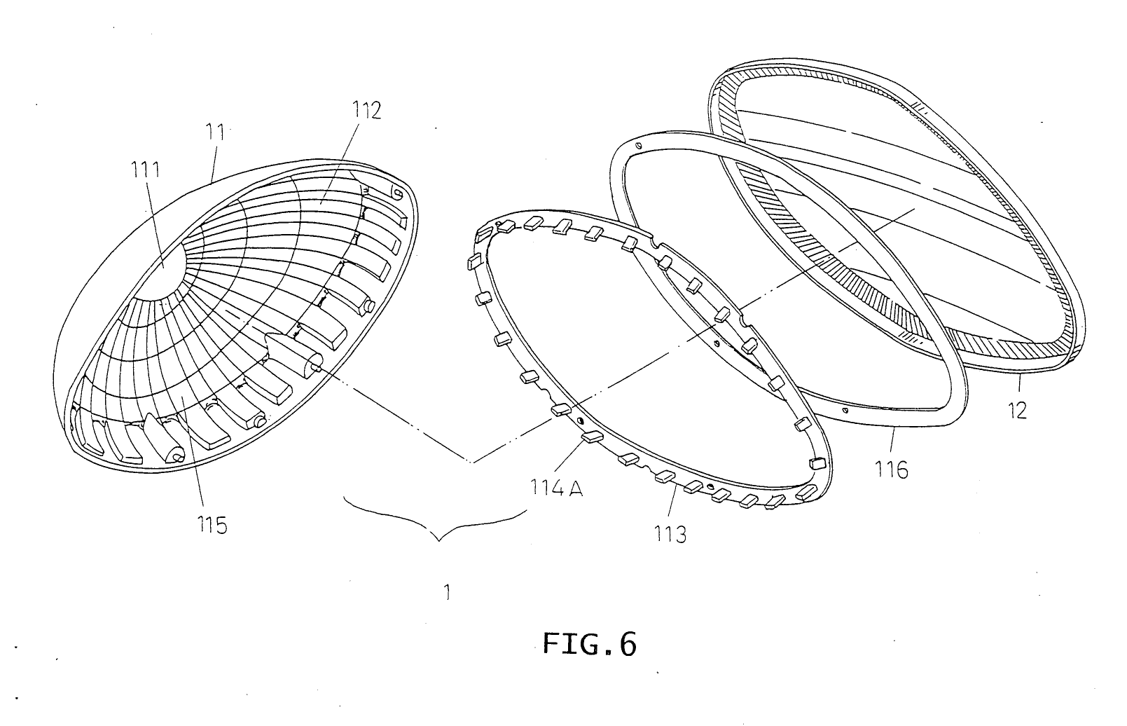

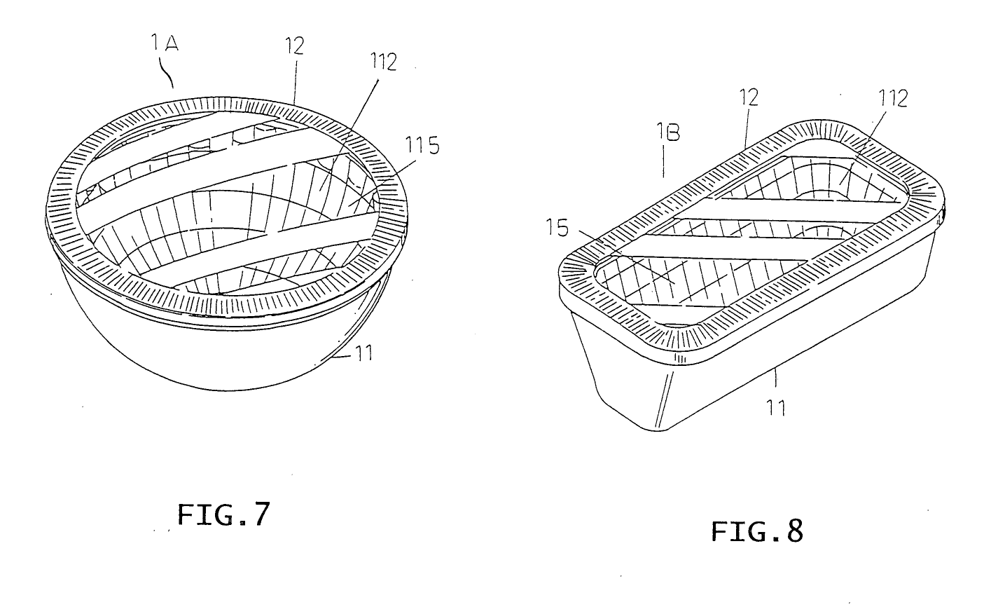

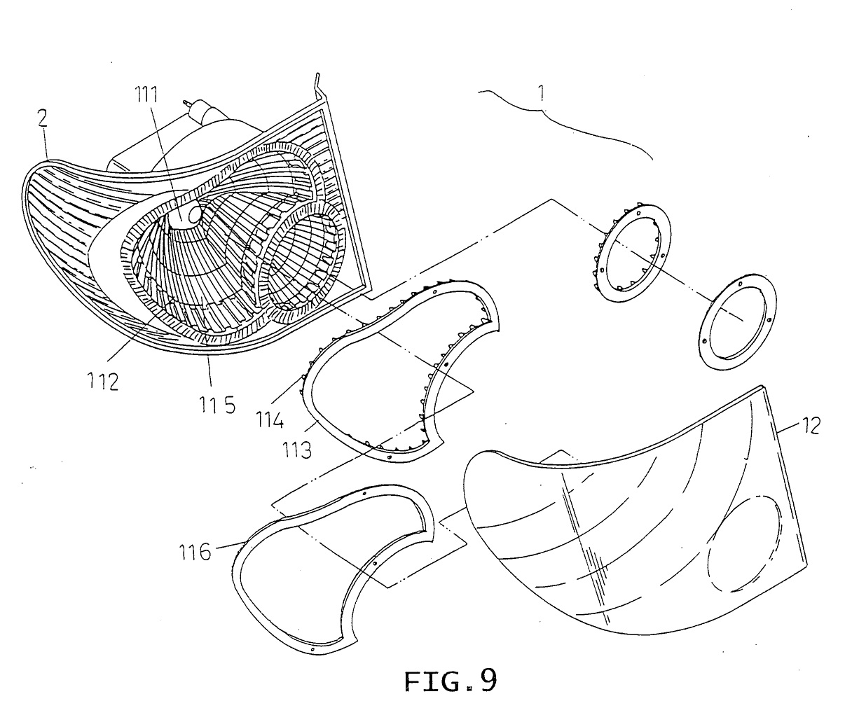

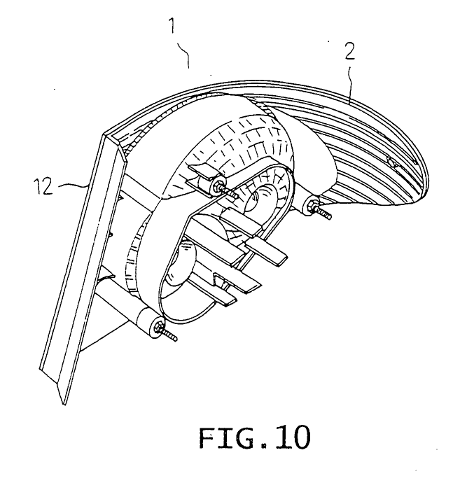

FIG. 6 illustrates a modified embodiment of the invention, wherein each LED 114A is a parallelepiped. The vehicle light may have other shapes, such as the vehicle light 1A in FIG. 7 and the vehicle light 1B in FIG. 8. Referring to FIGS. 9 and 10, the vehicle light 1 in accordance with the present invention can be used with any light base 2 and thus can be used with any vehicle whenever appropriate.

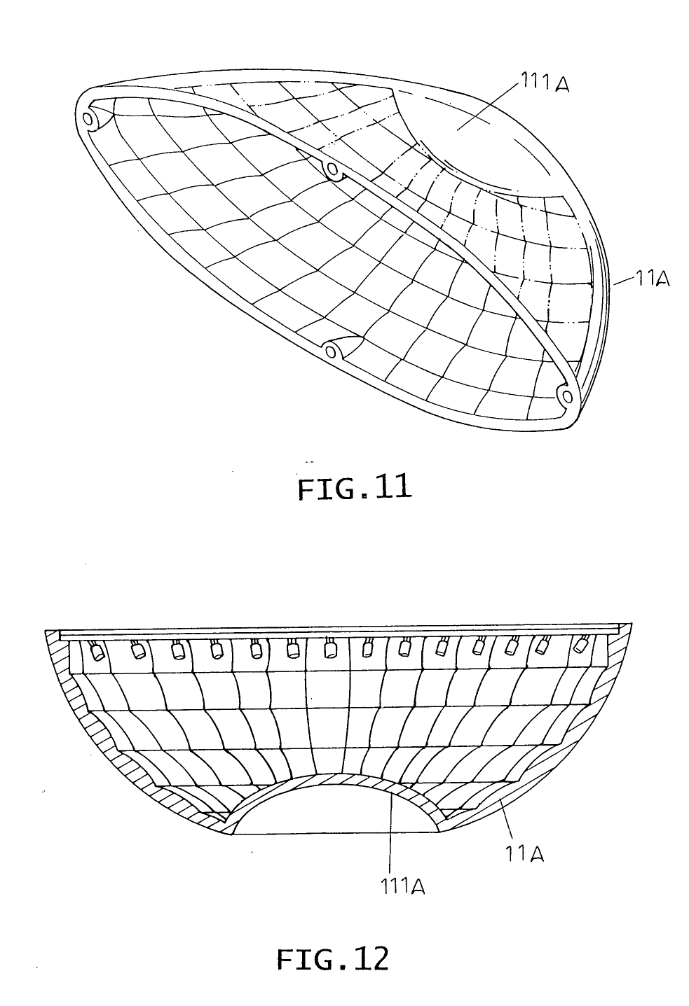

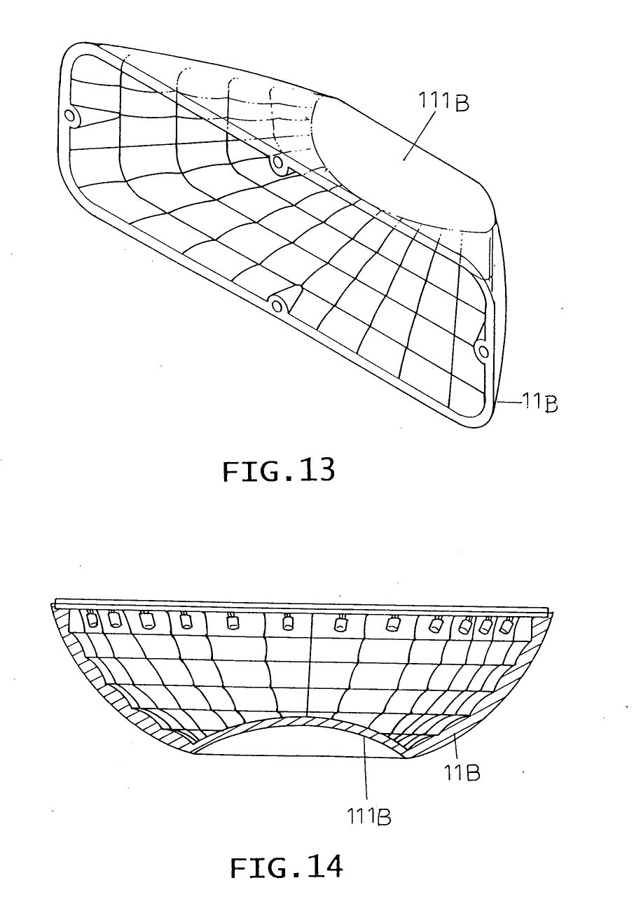

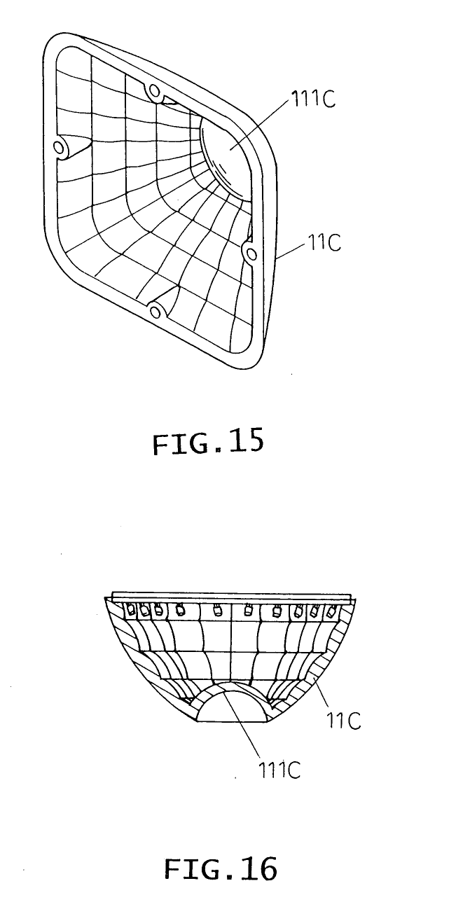

The protrusion 111 can be of other shapes, such as the protrusion 111A (oval when viewed in section) on the base 11A shown in FIGS. 11 and 12, the protrusion 111B (oval when viewed in section) on the base 11B shown in FIGS. 13 and 14, and the protrusion 111C on the base 11C shown in FIGS. 15 and 16.

The vehicle light with LEDs in accordance with the present invention provides a bright reflective interface as well as improved surrounding halo effect. An aesthetic and eye-catching visual effect is thus obtained. The light beam emitted by each LED is incident on the protrusion covered with a reflective material, providing a convergent effect. The light beams are reflected into parallel light beams, providing a larger illumination area and providing an improved halo effect. The light energy is scarcely wasted, as the light beam emitted by each LED is incident on the protrusion. The particles made of a reflective material make the light beams become brighter after scattering. Further, the LEDs may provide different colors when excited.

Although the invention has been explained in relation to its preferred embodiment, it is to be understood that many other possible modifications and variations can be made without departing from the scope of the invention as hereinafter claimed.

1. A vehicle light comprising:
a base having an open side, said base including an inner reflective surface that has a protrusion formed on a central portion thereof, said protrusion being covered with a reflective material;
a light-transmittable member attached to the open side of the base;
a circuit ring mounted to the open side of the base; and
a plurality of spaced light-emitting diodes mounted on said circuit ring;
a light beam emitted by each said light-emitting diode being incident on said protrusion to provide a convergent effect, said light beams being then reflected by said protrusion and said inner reflective surface to provide a large illumination area.

2. The vehicle light as claimed in claim 1, wherein each said light-emitting diode is a parallelepiped.

3. The vehicle light as claimed in claim 1, wherein said protrusion is oval when viewed in section.

4. The vehicle light as claimed in claim 1, wherein said light-emitting diodes emit light beams of different colors when excited.

5. The vehicle light as claimed in claim 1, wherein said inner reflective surface includes a plurality of particles provided thereon, said particles being made of a reflective material.

6. The vehicle light as claimed in claim 1, wherein the protrusion has an arcuate surface.
